(19) United States
(12) Patent Application Publication
(10) Pub. No.: US 2003/0237080 A1
(43) Pub. Date: Dec. 25, 2003

(54) System and method for improved register allocation in an optimizing compiler

(76) Inventors: Carol Thompson, San Jose, CA (US); Uma Srinivasan, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/177,343

(22) Filed: Jun. 19, 2002

(51) Int. Cl. G06F 9/45; G06F 15/00

(52) U.S. Cl. 717/161; 717/150; 712/241

(57) ABSTRACT

Systems and methods for improving an optimizing compiler are disclosed. A representative compiler, includes: a translation engine and a low-level instruction optimizer, the low-level instruction optimizer further includes a scheduler and register allocator, the scheduler and register allocator comprising: a minimum initiation interval determiner; a modulo scheduler; a rotating register allocator configured to receive a schedule, allocate and assign rotating registers responsive to modulo schedule, and communicate a status of a set of rotating registers; a static register allocator configured to receive the schedule, allocate and assign scalar variables to a set of scalar registers responsive to the modulo schedule and the status; and a rotating register spiller configured to receive and store interfering variables in a memory. A representative method includes the following steps: identifying a plurality of variables having a lifetime that exceeds an initiation interval; allocating a rotating register for each of the identified plurality of variables; assigning one of the plurality of variables to a respective rotating register when the variable was initiated within the source code programming loop; and communicating rotating register usage to a scalar register allocator, wherein the scalar register allocator assigns variables outside of the source code programming loop to an allocated but unassigned rotating register.

### TECHNICAL FIELD

The present invention generally relates to register allocation and assignment. More particularly, a system and method for register allocation and assignment in an optimizing compiler.

### BACKGROUND OF THE INVENTION

Most software that you buy or download is provided as a compiled set of executable instructions. Compiled means that the actual program code that the developer created, known as the source code, has been transformed via another software program called a compiler. A compiler translates the source code written in a high-level language such as FORTRAN, C, or C++, into a format that a particular type of computing platform can understand, such as an assembler or machine language.

The compiler derives its name from the way it works. Compilers analyze the entire source code, collect and reorganize the various instructions, and generate a low-level equivalent of the original source code. A compiler differs from an interpreter, which analyzes and executes each line of source code individually. Consequently, an interpreter can execute source code nearly immediately. Compilers, on the other hand, require some time before they can generate an executable program. However, executables produced by compilers run much faster than executables generated with an interpreter over the same source code. Because compilers translate source code into machine-level code, many compilers are required for each high-level language. For example, there are a set of FORTRAN compilers for personal computers (PCs) and another set of FORTRAN compilers for Apple Macintosh computers.

Optimizing compilers aggressively transform source code to generate compiled executable programs with increased run-time execution speed and/or a minimized run-time code size. Most optimizations are applied locally (within basic blocks of code), globally (over each C/C++ function, Java byte code method, or FORTRAN subprogram), and “interprocedurally” (over all C/C++ functions, Java byte code class files, or FORTRAN subprograms submitted for conpilation). Some optimizing compilers repeatedly analyze and transform the source code as the application of one optimization may create additional opportunities for application of a previously applied optimization.

A compiler's tasks may be divided into an analysis state followed by a synthesis stage, as explained in “Compilers; Principles, Techniques, and Tools,” by A. Aho et al. (Addison Wesley, 1988) pp. 2-22. The product of the analysis stage may be thought of as an intermediate representation of the source program; i.e., a representation in which lexical, syntactic, and semantic evaluations and transformations may have been performed to make the source code easier to synthesize. The synthesis stage may considered to consist of two tasks: code optimization, in which the goal is generally to increase the speed at which the target program will run on the computer, or possibly to decrease the amount of resources required to run the target program; and code generation, in which the goal is to actually generate the target code, typically machine code or assembly code.

A compiler that is particularly well suited to one or more aspects of the code optimization task may be referred to as an optimizing compiler. Optimizing compilers are of increasing importance for several reasons. First, the work of an optimizing compiler frees programmers from undue concerns regarding the efficiency of the high-level programming code that they write. Instead, the programmers can focus on high-level program constructs and on ensuring errors in program design or implementation are avoided. Second, designers of computers that are to employ optimizing compilers can configure hardware based on parameters dictated by the optimization process rather than by the non-optimized output of a compiled high-level language. Third, the increased use of microprocessors that are designed for instruction level parallel (ILP) processing, such as a reduced instruction set computer (RISC) and very long instruction word (VLIW) microprocessors, presents new opportunities to exploit such processing through a balancing of instruction level scheduling and register allocation.

There are various strategies that an optimizing compiler may pursue. One large group of such strategies focus on optimizing transformations, such as are described in D. Bacon et al., “Compiler Transformations for High-Performance Computing,” in ACM Computing Surveys, Vol. 26, No. 4 (Dec. 1994) at pp. 345-420. Such transformations often involve high-level, machine-independent, programming operations. Removing redundant operations, simplifying arithmetic expressions, removing code that will never be executed, removing invariant computations from loops, and storing values of common sub-expressions rather than repeatedly computing them are some examples. Such machine-independent transformations are referred to as high-level optimizations.

Other strategies employ machine-dependent transformations. Such machine-dependent transformations are referred to as low-level optimizations. Two important types of low-level optimizations are: (a) instruction scheduling and (b) register allocation. Both high-level and low-level optimization strategies are often focused on loops in the code. Optimization strategies focus on programming loops, because in many applications, the majority of execution time is spent processing the loops.

A principal goal of some instruction scheduling strategies is to permit two or more operations within a loop to be executed via ILP processing. ILP processing generally is implemented in processors with multiple execution units. One way of communicating with the central processing unit (CPU) of the computer system is to create VLIWs. VLIWs specify the multiple operations that are to be executed in a single machine cycle.

For example, a VLIW may instruct one execution unit to begin a memory load and a second to begin a memory store, while a third execution unit is processing a floating-point multiplication. Each such execution task has a latency period; i.e., the task may take one, two, or more clock cycles to complete. The objective of ILP processing is to optimize the use of the execution units by minimizing the instances in which an execution unit is idle during an execution cycle. ILP processing may be implemented by the CPU or, alternatively, by an optimizing compiler. Using a CPU hardware approach to coordinate and execute ILP processing, however, may be complex and result in an approach that is not as easy to change or update as the use of an appropriately designed optimizing compiler.

One known technique for improving instruction level parallelism in loops is referred to as software pipelining. As described in the work by D. Bacon et al. referred to above, the operations of a single-loop iteration are separated into s stages. After transformation, which may require the insertion of startup code to fill the pipeline for the first s-1 iterations, and cleanup code to drain it for the last s-1 iterations, a single iteration of the transformed code will perform stage 1 from pre-transformation iteration i, stage 2 from pre-transformation iteration i-1, and so on. Such a single iteration is known as the kernel of the transformed code. A particular known class of algorithms for achieving software pipelining is referred to as modulo scheduling, as described in James C. Dehnert and Ross A. Towle, “Compiling for the Cydra 5,” in The Journal of Supercomputing, vol. 7, pp. 181, 190-197 (1993; Kluwer Academic Publishers, Boston).

As noted above, another group of low-level optimization strategies involves register allocation. Some of these strategies share the goal of improved allocation and assignment of registers used in performing loop operations. The allocation of registers generally involves the selection of variables to be stored in registers during certain portions of the compiled computer program. The subsequent step of assignment of registers involves choosing specific registers in which to place the variables. Unless the context requires otherwise, references hereafter to the allocation or use of registers will be understood to include the assignment of registers. The term “variable” will generally be understood to refer to a quantity that has a “live range” during the portion of the computer program under consideration. Specifically, a variable has a “live range” over a plurality of executable statements within the computer program if that portion of the computer program may be included in a control path having a preceding point at which the variable is defined and a subsequent point at which the variable is used. Thus, register allocation may alternatively be described as referring to the selection of “live ranges” to be stored in registers, and register assignment as the assignment of a specific physical register to one of the live ranges previously selected for such assignments.

Registers are high-speed memory locations in the CPU generally used to store the value of variables. They are a high-value resource because they may be read from or written to very quickly. Typically, two registers can be read and a third written in a single machine cycle. In comparison, a single access to random-access memory (RAM) may require several machine cycles to complete. Registers typically are also a relatively scarce resource. In comparison to the large number of words of RAM addressable by the CPU, typically numbered in the millions and requiring tens of bits to address, the number of registers will often be on the order of ten or a hundred and therefore require only a small number of bits to address. Because of their high value in terms of speed, the decisions of how many and which kind of registers to allocate may be the most important decisions in determining how quickly the program will run. For example, a decision to allocate a frequently used variable to a register may eliminate a multitude of time-consuming reads and writes of that variable from and to memory. This allocation decision often will be the responsibility of an optimizing compiler.

Register allocation is a particularly difficult task however, when combined with the goal of minimizing the idle time of multiple execution units by implementing ILP processing through instruction level scheduling. Instruction level scheduling optimizations that increase parallelism often also require an increased number of registers to process the parallel operations. If a situation occurs in which a register is not available to perform an operation when required by the optimized schedule, it is necessary to “spill” one or more registers. That is, the contents of the spilled registers are temporarily moved to RAM to make room for the operations that must be performed, and moved back again when the register bottleneck is alleviated. As previously noted, the process of moving register contents (i.e., information) to and from RAM is relatively time consuming and thus tends to undermine the efficiencies that may be realized using instruction schedule optimization. A compiler may implement this undesirable but necessary spilling procedure by adding spill code at the location in the compiled code where the register deficiency occurred, or at another advantageous location that minimizes the number of register spills or reduces the amount of time needed to implement and recover from such spills.

Methods have been developed in an attempt to achieve a balance between register allocation and software pipelining, which, as noted above, is a particular approach to achieving ILP processing. Such known methods generally are limited, however, by the fact that they are concerned with the allocation and assignment of registers to live ranges within loops, particularly to loops that have been modulo scheduled. Such live ranges are loop-variant because they are defined or used within a loop. However, registers typically must also be allocated and assigned to live ranges outside of the modulo-scheduled loop; that is, to variables that are loop-invariant because they are not operated upon within the loop. Consequently, such known methods generally do not address the need to optimize the allocation and assignment of registers to both loop-variant and loop-invariant live ranges.

One such attempt to address this need is described in B. Rau, et al., “Register Allocation for Software Pipelined Loops,” in Proceedings of the SIGLPLAN '92 Conference on PLDI (1992) at pp. 283-286, the contents of which are hereby incorporated by reference. Although the method therein described provides for the allocation and assignment of certain types of registers to modulo scheduled loops, it does not provide a way of allocating and assigning registers both with respect to loop-variant and loop-invariant live ranges; i.e., globally over the procedure being executed.

Another attempt to address this need is described in Q. Ning and Guang R. Gao, “A Novel Framework of Register Allocation for Software Pipelining,” in Proceedings of the SIGPLAN '93 Conference on POPI, (1993) at pp. 29-42, the contents of which are hereby incorporated by reference. The method described in that article (hereafter, the “Ning-Gao method”) makes use of register allocation as a constraint on the software pipelining process. The Ning-Gao method generally consists of determining time-optimal schedules for a loop using an integer linear programming technique and then choosing the schedule that imposes the least restrictions on the use of registers.

One disadvantage of this method, however, is that it is quite complex and may significantly increase the time required for the compiler to compile a source program. Another significant disadvantage of the Ning-Gao method is that it does not address the need for, or impact of, inserting spill code. That is, the method assumes that the minimum-restriction criterion for register usage can be met because there will always be a sufficient number of available registers. However, this is not always a realistic assumption.

Another known method that attempts to provide for concurrent loop scheduling and register allocation and assignment while taking into account the potential need for inserting spill code is described in Jian Wang, et al., “Software Pipelining with Register Allocation and Spilling,” in Proceedings of the MICRO-27,” (1994) at pp. 95-99, the contents of which are hereby incorporated by reference. The method described in this article (hereafter, the “Wang method”) generally assumes that all spill code for a loop to be software pipelined is generated during instruction-level scheduling. Thus, the Wang method requires assumptions about the number of registers that will be available for assignment to the operations within the loop after taking into account the demand on register usage imposed by loop-invariant live ranges. Such assumptions may, however, prove to be inaccurate, thus requiring either unnecessarily conservative assumptions to avoid this possibility of repetitive loop scheduling and register allocation, or other variations of the method.

From the foregoing, it can be appreciated that further improvements to an optimizing compiler are desired.

### SUMMARY OF THE INVENTION

Systems and methods for improved register allocation in an optimizing compiler are presented. An optimizing compiler can be arranged with the following elements: a translation engine configured to receive source code and generate an intermediate representation of a source code programming loop; and a low-level instruction optimizer, the low-level instruction optimizer further including a scheduler and register allocator, the scheduler and register allocator having: a minimum initiation interval determiner configured to identify what is the optimal initiation interval for the given loop based on program dependence information and hardware resource constraints; a modulo scheduler configured to receive the intermediate representation and generate a schedule responsive to the source code programming loop; a rotating register allocator configured to receive the schedule, allocate and assign rotating registers responsive to the initiation interval, and communicate a status of a set of rotating registers; a rotating register spiller configured to transfer the contents of rotating registers to and from static registers for interfering variable's lifetimes; and a static register allocator configured to receive the schedule, allocate and assign scalar registers to a set of scalar variables responsive to the modulo schedule, the rotating register allocator and the status.

A representative method for improving register allocation in an optimizing compiler includes the following steps: identifying a plurality of variables having a lifetime that exceeds an initiation interval of a present source code programming loop of interest; allocating a rotating register for each of the identified plurality of variables; assigning one of the plurality of variables to a respective rotating register when the variable was initiated within the source code programming loop; and communicating rotating register usage to a scalar register allocator, wherein the scalar register allocator assigns variables outside of the source code programming loop to an allocated but unassigned rotating register.

Other systems, methods, and features of the present invention will be or become apparent to one skilled in the art upon examination of the following drawings and detailed description. It is intended that all such additional systems, methods, and features are included within this description, are within the scope of the present invention, and are protected by the accompanying claims.

### BRIEF DESCRIPTION OF THE DRAWINGS

Systems and methods for improved register allocation in an optimizing compiler are illustrated by way of example and not limited by the implementations in the following drawings. The components in the drawings are not necessarily to scale. Emphasis instead is placed upon clearly illustrating the principles of the present invention. Moreover, in the drawings, like reference numerals designate corresponding parts throughout the several views.

FIG. 1 is a schematic diagram of an embodiment of a general-purpose computing device that includes an optimizing compiler in accordance with the present invention.

FIG. 2 is a schematic diagram illustrating an embodiment of the optimizing compiler of FIG. 1.

FIG. 3 is a schematic diagram illustrating an embodiment of the translation engine of FIG. 2.

FIG. 4 is a schematic diagram illustrating an embodiment of the low-level instruction optimizer of FIG. 3.

FIG. 5 is a schematic diagram illustrating an embodiment of the scheduler & register allocator of FIG. 4.

FIGS. 6A-6B are a schematic diagram illustrating an embodiment of the modulo scheduler & register allocator of FIG. 5.

FIG. 7 is a schematic diagram illustrating an embodiment of the rotating register allocator of FIG. 6A.

FIG. 8 is a schematic diagram illustrating an embodiment of the modulo schedule instruction generator of FIG. 6B.

FIG. 9 is a flow diagram illustrating an embodiment of a representative method for improved register allocation that can be implemented by the optimizing compiler of FIG. 1.

### DETAILED DESCRIPTION OF THE PREFERRED EMBODIMENT

The systems and methods for improved register allocation in an optimizing compiler account for practical constraints on the number of available registers and the allocation and assignment of registers to both loop-variant and loop-invariant live ranges. The improved optimizing compiler coordinates register allocation and assignment by rotating and scalar register allocators to generate efficient global (i.e., over the entire transformed source code) hardware register assignments.

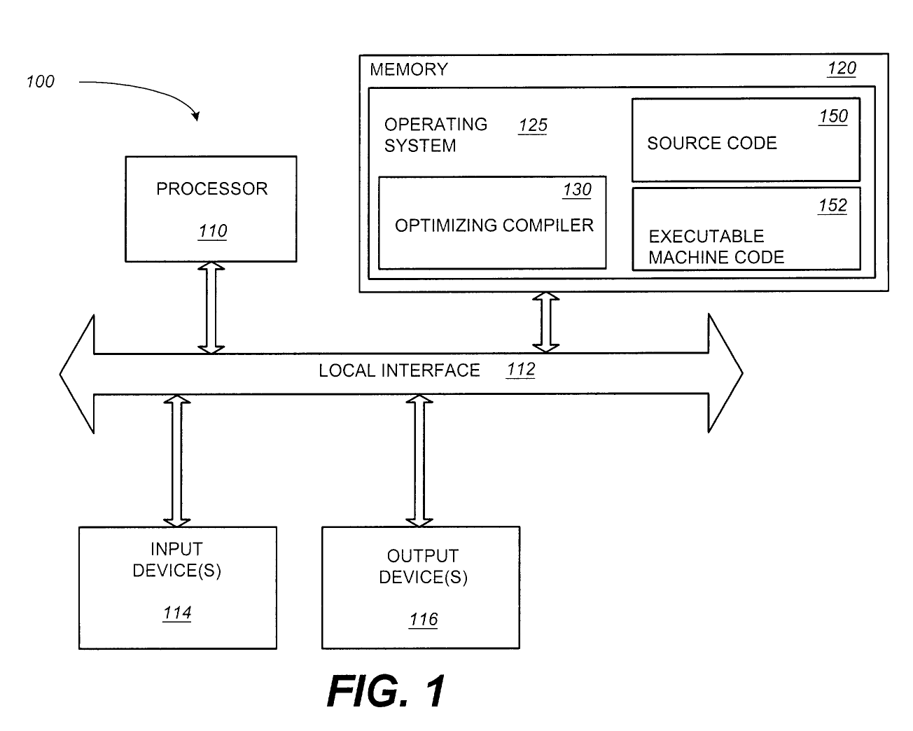

Referring now in more detail to the drawings, in which like numerals indicate corresponding parts throughout the several views, FIG. 1 presents a functional block diagram illustrating an embodiment of a general-purpose computing device 100 that includes an optimizing compiler 130 in accordance with the present invention. The general-purpose computing device 100 includes a processor 110, input device(s) 114, output device(s) 116, and a memory 120 that communicate with each other via a local interface 112. The local interface 112 can be, but is not limited to, one or more buses or other wired or wireless connections as is known in the art. The local interface 112 may include additional elements, such as buffers (caches), drivers, and controllers (omitted here for simplicity), to enable communications. Further, the local interface 112 includes address, control, and data connections to enable appropriate communications among the aforementioned components.

The processor 110 is a hardware device for executing software stored in memory 120. The processor 110 can be any custom made or commercially available processor, a central processing unit (CPU) or an auxiliary processor associated with the general-purpose computing device 100, or a semiconductor based microprocessor (in the form of a microchip) or a macroprocessor.

The input device(s) 114 may include, but are not limited to, a keyboard, a mouse, or other interactive pointing devices, voice activated interfaces, or other suitable operator-machine interfaces (omitted for simplicity of illustration). The input device(s) 114 can also take the form of a data file transfer device (i.e., a floppy-disk drive (not shown)). Each of the various input device(s) 114 may be in communication with the processor 110 and/or the memory 120 via the local interface 112. It will be understood that the input device(s) 114 may be used to receive, and/or generate source code 150 that the optimizing compiler 130 translates into an executable machine code 152 (i.e., a processor specific machine level representation of the source code 150).

The output device(s) 116 may include a video interface that supplies a video output signal to a display monitor associated with the respective general-purpose computing device 100. Display devices (not illustrated) that can be associated with the respective general-purpose computing device 100 can be conventional CRT based displays, liquid crystal displays (LCDs), plasma displays, image projectors, or other display types. It should be understood, that various other output device(s) 116 (not shown) may also be integrated via local interface 112 and/or via network interface device(s) 214 to other well-known devices such as plotters, printers, etc. The output device(s) 214, while not required by the present invention, may prove useful in providing status and/or other information to an operator of the general-purpose computing device 100.

The memory 120 can include any one or a combination of volatile memory elements (e.g., random-access memory (RAM, such as dynamic RAM or DRAM, static RAM or SRAM, etc.)) and nonvolatile-memory elements (e.g., read-only memory (ROM), hard drive, tape drive, compact disc (CD-ROM), etc.). Moreover, the memory 120 may incorporate electronic, magnetic, optical, and/or other types of storage media. Note that the memory 120 can have a distributed architecture, where various components are situated remote from one another that are accessible via firmware and/or software operable on the processor 110.

The software in memory 120 may include one or more separate programs and data files. For example, the memory 120 may include the optimizing compiler 130 and source code 150. Each of the one or more separate programs will comprise an ordered listing of executable instructions for implementing logical functions. Furthermore, the software in the memory 120 may include an operating system 125. The operating system 125 essentially controls the execution of other computer programs, such as the optimizing compiler 130 and other programs that may be executed by the general-purpose computing device 100. Moreover, more than one operating system may be used by the general-purpose computing device 100. An appropriately configured general-purpose computing device 100 may be capable of executing programs under multiple operating systems 125. The operating system 125 provides scheduling, input-output control, file and data management, memory management, and communication control and related services.

It should be understood that the optimizing compiler 130 can be implemented in software, firmware, hardware, or a combination thereof The optimizing compiler 130, in the present example, can be a source program, executable program (object code), or any other entity comprising a set of instructions to be performed. When in the form of a source program, the optimizing compiler 130 is translated via a compiler, assembler, interpreter, or the like, which may or may not be included within the memory 120, to operate in connection with the operating system 125. Furthermore, the optimizing compiler 130 can be written as (a) an object-oriented programming language, which has classes of data and methods, or (b) a procedure-programming language, which has routines, subroutines, and/or functions, for example but not limited to, C, C++, C Sharp, Pascal, Basic, Fortran, Cobol, PERL, Java, and Ada. It will be understood by those having ordinary skill in the art that the implementation details of the optimizing compiler 130 will differ based on the underlying technology and architecture used in constructing processor 110.

When the general-purpose computing device 100 is in operation, the processor 110 executes software stored in memory 120, communicates data to and from memory 120, and generally controls operations of the coupled input device(s) 114, and the output device(s) 116 pursuant to the software. The optimizing compiler 130, the operating system 125, and any other applications are read in whole or in part by the processor 110, buffered by the processor 110, and executed.

When the optimizing compiler 130 is implemented in software, as shown in FIG. 1, it should be noted that the logic contained within the optimizing compiler 130 can be stored on any computer-readable medium for use by or in connection with any computer-related system or method. In the context of this document, a computer-readable medium is an electronic, magnetic, optical, or other physical device or means that can contain or store a computer program for use by, or in connection with a computer-related system or method. The computer-readable medium can be, for example but not limited to, an electronic, magnetic, optical, electromagnetic, infrared, or semiconductor system, apparatus, device, or propagation medium.

### Optimizing Compiler—Architecture and Operation

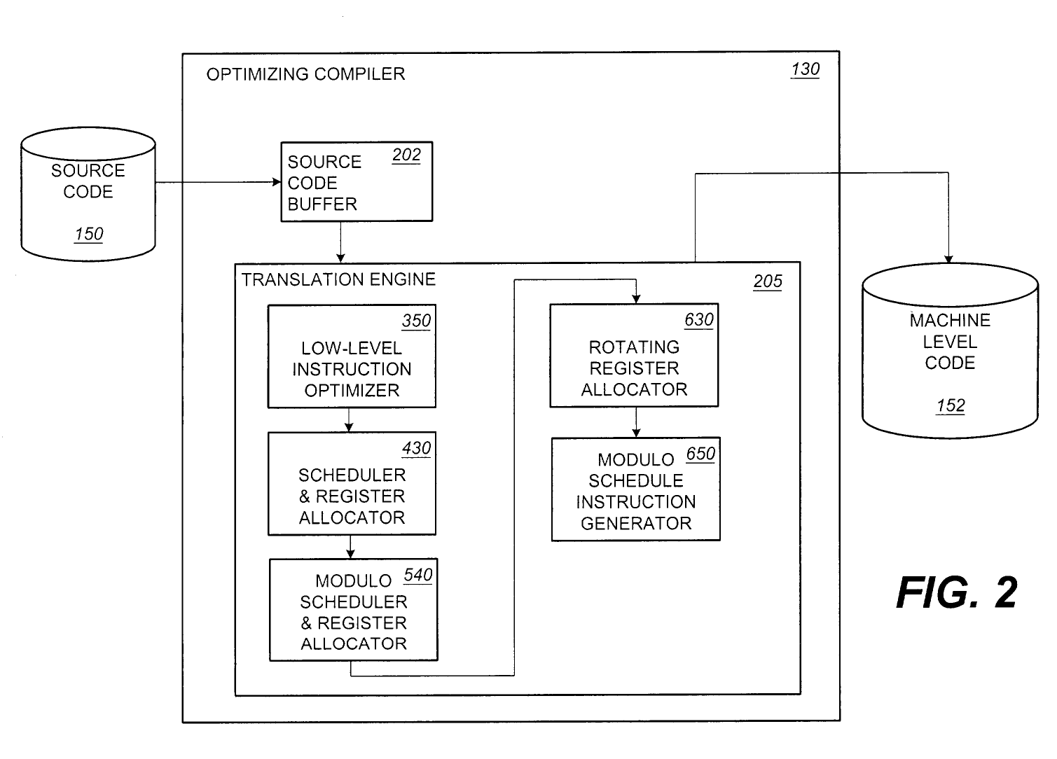

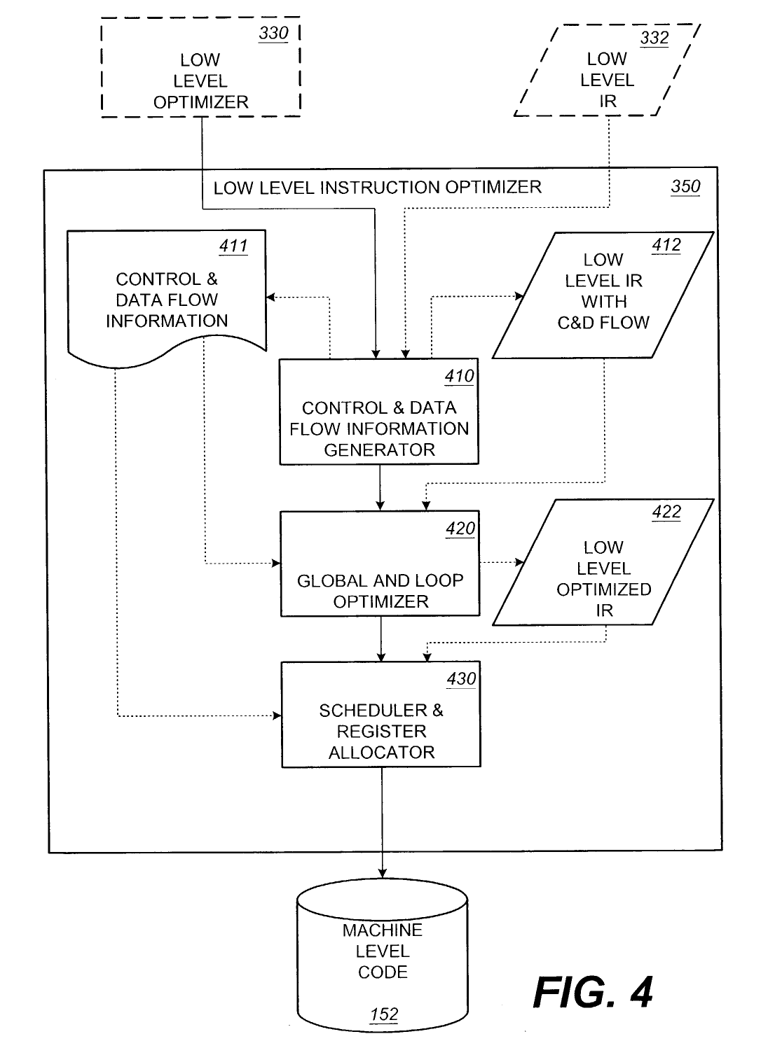

Reference is now directed to the functional-block diagram of FIG. 2, which illustrates the optimizing compiler 130 of FIG. 1. The optimizing compiler 130 receives source code 150 and generates machine-level code 152. As illustrated in FIG. 2, the optimizing compiler 130 includes a source code buffer 202 and translation engine 205. The source code buffer 202 receives the source code 150 and forwards the source code 150 to the translation engine 205. The translation engine 205 includes low-level instruction optimizer 350, scheduler and register allocator 430, modulo scheduler and register allocator 540, rotating-register allocator 630, and modulo-schedule instruction generator 650. Each of the above-referenced elements will be described in detail concerning FIGS. 4 through 8.

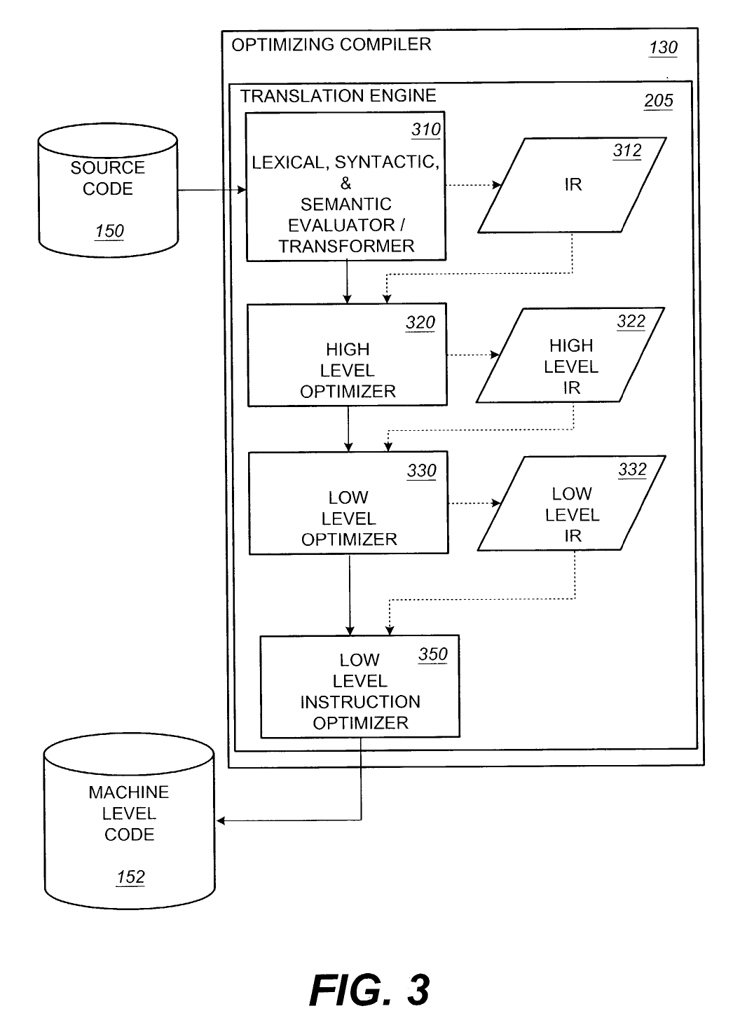

FIG. 3 illustrates an embodiment of the translation engine 205 of FIG. 2. More specifically, FIG. 3 illustrates source-code flow through a portion of the transformation from source code 150 to machine-level code 152. The received source code 150 arrives at the lexical, syntactic, and semantic evaluator/transformer 310.

The lexical, syntactic, and semantic evaluator/transformer 310 generates an intermediate representation (IR) 312 of the received source code 150. The translation engine 205 forwards IR 312 to high-level optimizer 320. High-level optimizer 320 scans the IR 312 and identifies machine-independent (i.e., processor independent), programming operations. The high-level optimizer 320 removes redundant operations, simplifies arithmetic expressions, removes portions of source code 150 that will never be executed, removes invariant computations from loops, stores values of common sub-expressions, etc. The high-level optimizer generates high-level IR 322 (i.e., a second-level representation of the source code 150).

Once the high-level optimizer 320 has completed processing of IR 312, the translation engine 205 forwards high-level IR 322 to the low-level optimizer 330. Low-level optimizer 330 transforms high-level IR 322 into low-level IR 332 (i.e., a third-level representation of the received source code 150). Low-level optimizer 330 applies processor-dependent transformations, such as instruction scheduling and register allocation to generate low-level IR 332. As shown in FIG. 3, the translation engine 205 forwards low-level IR 332 to the low-level instruction optimizer 350. The low-level instruction optimizer 350 identifies program and data flows, optimizes programming loops, and applies a scheduler and register allocator to the result.

The low-level instruction optimizer 350 is illustrated in FIG. 4. As described above, the low-level instruction optimizer 350 receives low-level IR 332 from the low-level optimizer 330. The low-level instruction optimizer 350 applies the low-level IR 332 in control and data-flow information generator 410. The control and data-flow information generator 410 generates control and data-flow information 411 and a low-level IR with control and data-flow information 412 (i.e., a fourth-level representation of the source code 150). The low-level instruction optimizer 350 forwards the control and data-flow information 411 and a low-level IR with control and data-flow information 412 to a global and loop optimizer 420. The global and loop optimizer 420 identifies any efficiencies (e.g., by locating and removing redundant portions) of the low-level IR with control and data flow information 412. The global and loop optimizer 420 generates a low-level optimized IR 422 (i.e., a fifth-level representation of the source code 150). The low-level instruction optimizer 350 forwards the low-level optimized IR 422 to the scheduler and register allocator 430. The scheduler and register allocator 430 generates a schedule representation of the low-level optimized IR 422, identifies interfering variable lifetimes, and identifies program loops that can be modulo scheduled. Interfering variable lifetimes are live across program loops. Interfering variable lifetimes are associated with variables that are live both in and outside the program loop. For some hardware architectures, interfering lifetimes correspond to incoming arguments in a register for a subroutine or outgoing register arguments to a call from within the subroutine. The optimizing compiler 130 saves and restores register information by generating code to copy from a rotating register to a scalar register before the program loop and copy back from the scalar register to the same rotating register after completion of loop processing for variables with interfering lifetimes.

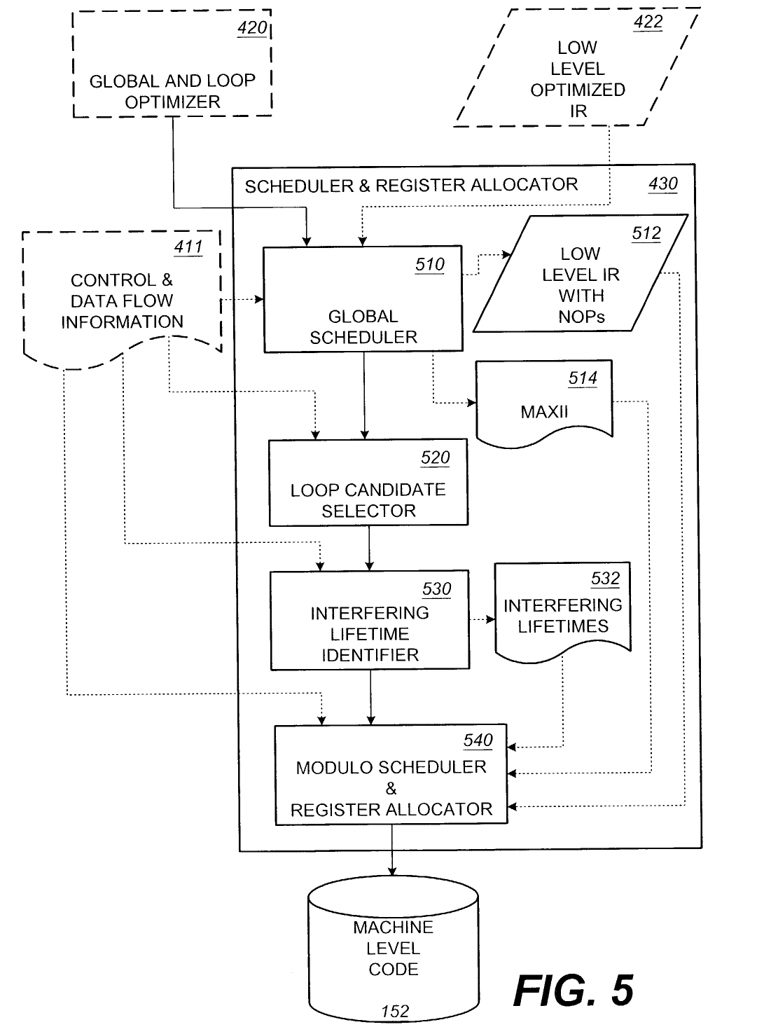

FIG. 5 illustrates an embodiment of the scheduler and register allocator 430 of FIG. 4. The scheduler and register allocator 430 receives the low-level optimized IR 422 from the global and loop optimizer 420. The scheduler and register allocator 430 forwards the low-level optimized IR 422 to global scheduler 510. The global scheduler 510, using control and data flow information 411 inserts no operation (NOPs) place holders in the low-level optimized IR 422 to generate a low-level IR with NOPs (i.e., a sixth-level representation of the source code 150). In addition, as illustrated in FIG. 5, the global scheduler 510 identifies and/or otherwise associates a maximum initiation interval (MAXII) 514 with each of the program loops identified in the low-level IR with NOPs 512. The MAXII 514 is a representation of the time that a loop is active during program operation.

A representation of a global schedule is forwarded from the global scheduler 510 along with control and data flow information 411 to the loop candidate selector 520. The loop candidate selector 520 associates an identifier with each program loop in the global schedule. As further illustrated in FIG. 5, each program loop is processed by an interfering lifetime identifier 530. The interfering lifetime identifier 530 locates and records the lifetimes of variables found throughout the global schedule (i.e., global variables that may be found in one or more program loops identified by the loop candidate selector 520.) in interfering lifetimes 532. The scheduler and register allocator 430 forwards control and data flow information 411, the interfering lifetimes 532, MAXII 514 and the low-level IR with NOPs to the modulo scheduler and register allocator 540. The modulo scheduler and register allocator 540 determines when loop specific variables are active, generates a modulo schedule of each of the program loops, manages rotating registers, spills registers as may be required, generates a set of instructions responsive to the modulo schedule, and manages static registers.

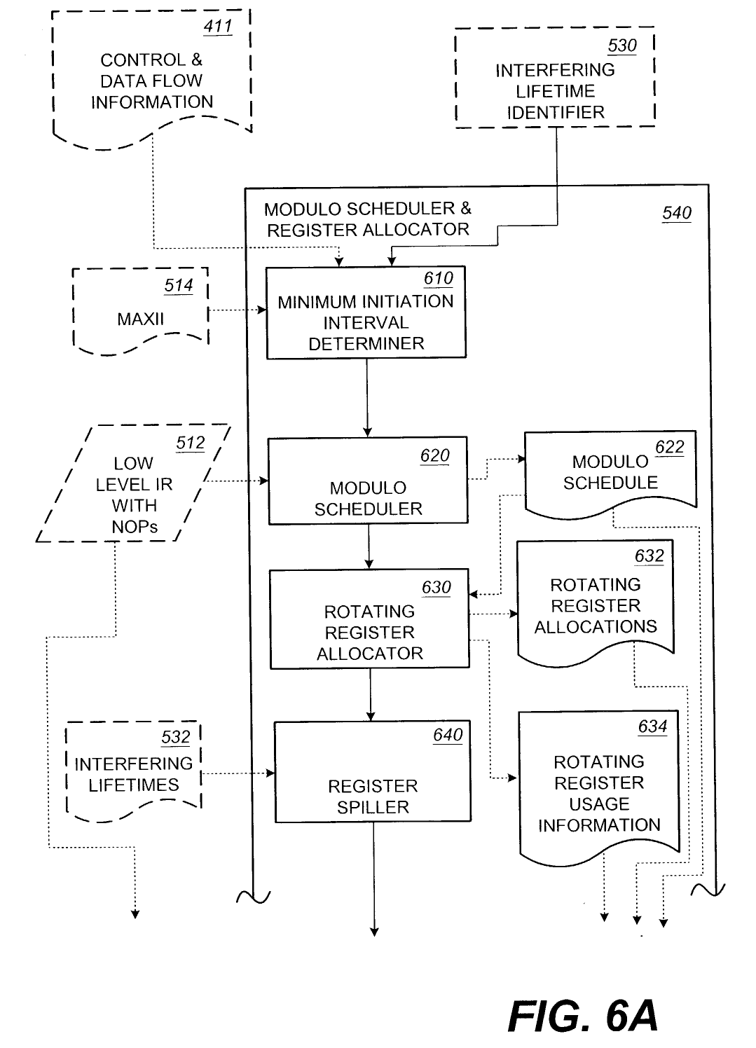

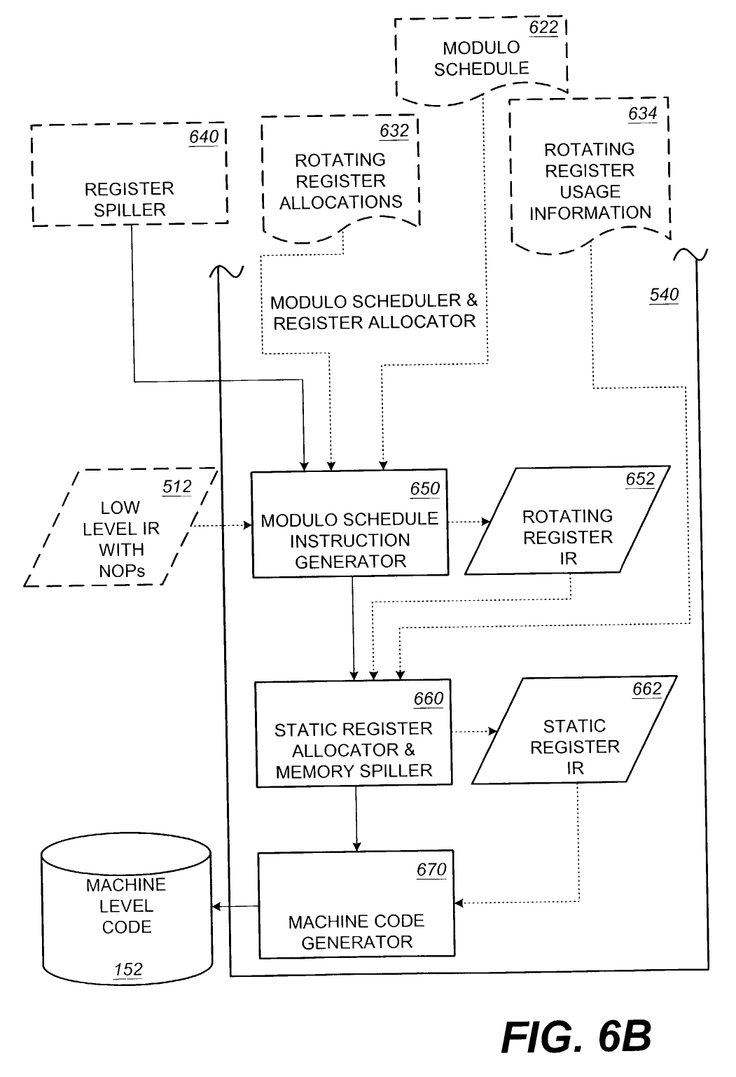

FIGS. 6A-6B illustrate an embodiment of the modulo scheduler and register allocator 540 of FIG. 5. The modulo-scheduler and register allocator 540 receives the control and data information 411 and the MAXII 514 and forwards the information to minimum initiation interval determiner 610. The minimum initiation interval determiner generates a representation (e.g., in clock cycles) of the minimum period that a program loop of interest is active. The minimum initiation interval is forwarded along with the low-level IR with NOPs to the modulo scheduler 620. The modulo scheduler 620 includes a class of algorithms for achieving software pipelining. The modulo scheduler 620 produces a modulo schedule 622 (i.e., a further representation of the source program) that the modulo scheduler and register allocator 540 forwards tot he rotating register allocator 630.

The rotating register allocator 630 contains logic configured to allocate and assign rotating hardware registers within processor 110. As indicated in the schematic of FIG. 6A, the rotating register allocator in addition to generating a set of rotating register allocations and assignments 632 produces rotating register usage information 634. As further illustrated in FIG. 6A, the rotating register allocator 630 forwards an indication of rotating register usage to register spiller 640. The register spiller 640 uses the rotating register usage information 634 and the interfering lifetimes 532 to determine when to spill the contents of specific rotating registers to a memory device (e.g., memory 120).

As indicated in the schematic diagram of FIG. 6B, the modulo schedule instruction generator 650 receives information from the register spiller 640, the rotating register allocations 632, the modulo schedule 622, and the low-level IR with NOPs 512. The modulo schedule instruction generator 650 constructs a rotating register IR 652 (i.e., another representation of the source code 150) from the inputs and forwards the rotating register IR 652 to a static register allocator and memory spiller 660. The static register allocator and memory spiller 660 uses the rotating register IR 652 and the rotating register usage information 634 to determine when it is appropriate to assign static or global variables to rotating registers. The static register allocator and memory spiller 660 generates a static register IR (i.e., a representation of the source code 150). In this way, the modulo scheduler and register allocator 540 takes advantage of available rotating register resources during the loop of interest. The modulo scheduler and register allocator 540 forwards the rotating register IR 652 and the static register IR 662 to the machine code generator 670, which in turns creates machine level code 152.

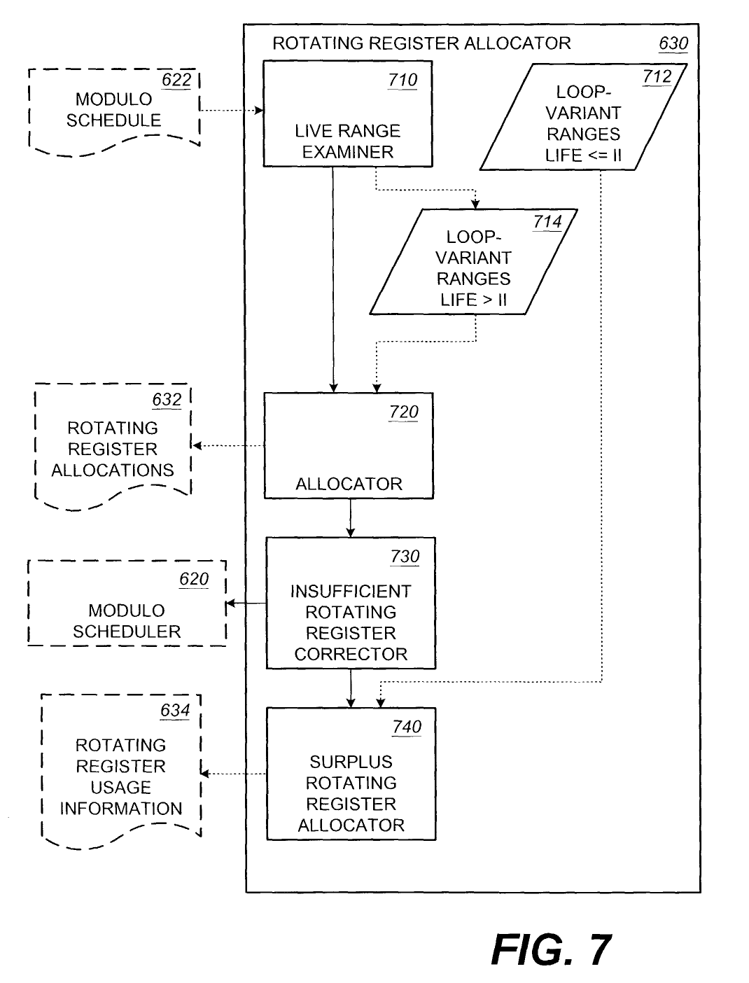

FIG. 7 is a schematic diagram illustrating an embodiment of the rotating register allocator 630 of FIG. 6A. The rotating register allocator 630 receives modulo schedule 622 and processes the schedule with live range examiner 710. The live range examiner determines the active variables over a present program loop of interest. In turn the active variables are further processed by logic that determines when identified live ranges are less than or equal to the initiation interval of the present program loop of interest. As indicated in the schematic, variables with live ranges that do not extend beyond the initiation interval 712 are forwarded to a surplus rotating register allocator, where the variables are applied to rotating registers and the result reported via rotating usage information 634. Conversely, variables with live ranges that exceed the initiation interval are forwarded to allocator 720. Allocator 720 applies these variables and reports the results via rotating register allocations 632. If during the process of allocating rotating registers, the allocator 720 is unable to meet the demands of the modulo schedule 622 for rotating registers, the insufficient rotating register corrector 730 is so informed. The insufficient rotating register corrector 730 adjusts the modulo schedule 620 accordingly.

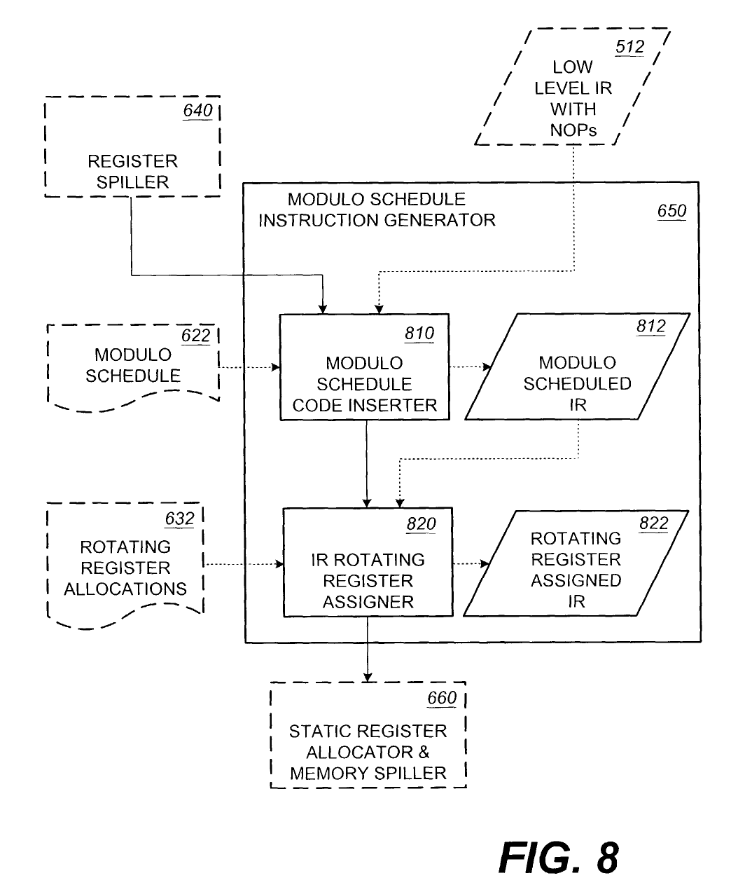

FIG. 8 illustrates an embodiment of the modulo schedule instruction generator 650 of FIG. 6B. The modulo schedule instruction generator 650 receives the low-level IR with NOPs 512, the modulo schedule 622, and status information from the register spiller 640 and forwards the information to the modulo schedule code inserter 810. The modulo schedule code inserter 810 transforms the modulo schedule 622 into a modulo scheduled IR 812. The modulo scheduled IR 812 is forwarded to an IR rotating register assigner 820 which receives the rotating register allocations 632 and applies the variables to the corresponding rotating registers to generate rotating register assigned IR 822. As further indicated in the schematic of FIG. 8, IR rotating register assigner 820 communicates a status indicating which rotating registers have been assigned variables to the static register allocator and memory spiller 660. As described above, the static register allocator and memory spiller 660 in turn can elect to assign static (e.g., global) variables to one or more available rotating registers in the processor 110.

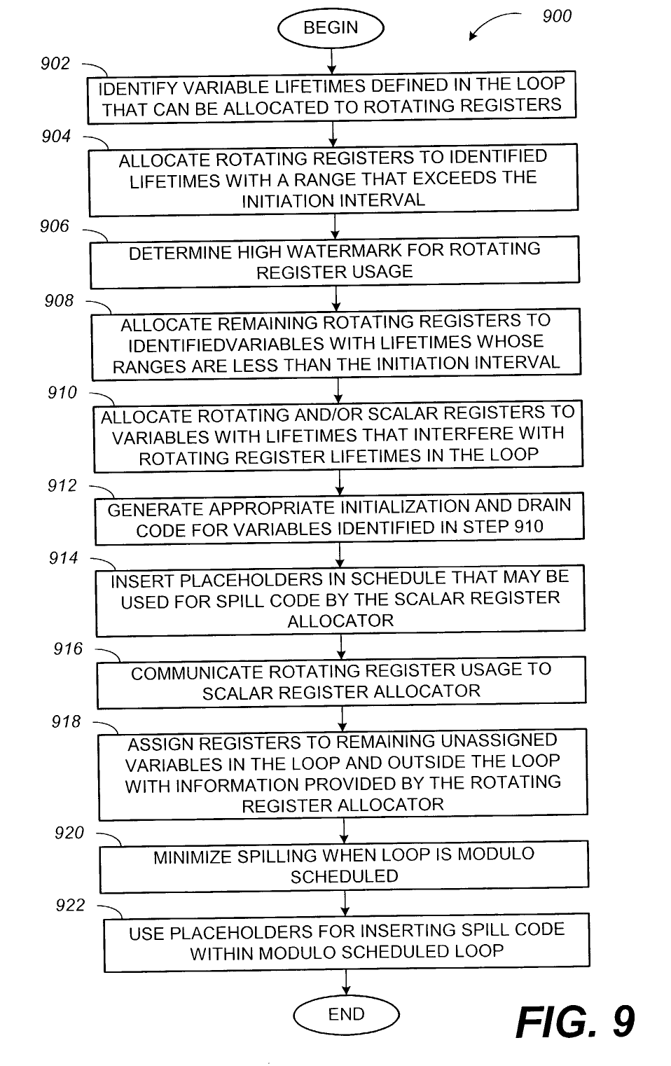

FIG. 9 is a flow diagram illustrating an embodiment of a representative method for improved register allocation that can be implemented by the optimizing compiler 130 of FIG. 1. The method 900 begins with step 902, where an optimizing compiler 130 in accordance with the present invention identifies variables having lifetimes defined in the present programming loop of interest that can be allocated to rotating registers. In step 904, the optimizing compiler 130 allocates rotating registers for each of the variables having lifetimes with a live range that exceeds the initiation interval. Next, in step 906, the optimizing compiler 130 is programmed to identify a high watermark for rotating register usage within the loop. A high watermark for rotating register usage is useful for a hardware architecture that stacks multiples of N rotating registers so that a program does not necessarily have to allocate all N registers at once. These hardware architectures enable a more efficient use of the rotating registers. For example, the rotating register allocator 630 determines how many registers are needed and rounds up to the next multiple of N. This multiple of N becomes the high watermark of rotating register usage.

In step 908, the optimizing compiler 130 allocates remaining rotating registers to variables having live ranges with durations less than the initiation interval of the loop Thereafter, in step 910, the optimizing compiler 130 allocates remaining rotating and/or scalar registers to variables with lifetimes that interfere with rotating registers containing variables having lifetimes in the loop.

In step 912, the optimizing compiler 130 generates appropriate initialization and drain code for variables identified in step 910, above. Next, in step 914, the optimizing compiler 130 inserts placeholders (e.g., NOPs) in the representation of the schedule that can be used by the scalar register allocator to insert spill code into the schedule. As illustrated in step 916, the optimizing compiler 130 is configured to communicate rotating register usage to the scalar register allocator. Thereafter, in step 918, the optimizing compiler 130 is configured to assign registers to remaining variables within the loop and outside the loop in accordance with information provided by the rotating register allocator. In step 920, the optimizing compiler 130 is configured to minimize spill code when the loop is modulo scheduled. In step 922, the optimizing compiler 130 uses the placeholders for inserting spill code within the modulo scheduled loop.

Any process descriptions or blocks in the flow diagram of FIG. 9 should be understood as representing modules, segments, or portions of code which include one or more executable instructions for implementing specific logical functions or steps in the process for improving register allocation in an optimizing compiler 130. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The detailed description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

Therefore, having thus described the invention, at least the following is claimed:

1. A method for improving register allocation in an optimizing compiler, comprising:
identifying a plurality of variables having a lifetime that exceeds an initiation interval of a present source code programming loop of interest;
allocating a rotating register for each of the identified plurality of variables;
assigning one of the plurality of variables to a respective rotating register when the variable was initiated within the source code programming loop; and
communicating rotating register usage to a scalar register allocator, wherein the scalar register allocator assigns variables outside of the source code programming loop to an allocated but unassigned rotating register.

2. The method of claim 1, further comprising:
inserting placeholders in the schedule, the placeholders identifying a location for spill code.

3. The method of claim 2, wherein the placeholder comprises a no-operation (NOP).

4. The method of claim 1, further comprising:
recognizing a pipeline processed intermediate representation of the source code; and
managing a scalar register allocator to minimize an amount of spill code generated within the loop of interest.

5. The method of claim 1, further comprising:
recognizing scalar lifetime values overwritten within the loop to generate a set of scalar lifetime values; and
reassigning the set of scalar lifetime values to static registers for the duration of the source code programming loop.

6. The method of claim 1, further comprising:
identifying a set of interfering lifetimes; and
spilling a corresponding set of values associated with the interfering lifetimes prior to allocating rotating registers.

7. The method of claim 1, wherein the scalar register allocator selects a rotating register for assigning a scalar lifetime variable value.

8. The method of claim 7, wherein the scalar register allocator selects the rotating register for assignment responsive to the rotating register usage information.

9. A computer-readable medium having a program for improving register allocation in an optimizing compiler, the program comprising:
logic configured to receive a representation of a source code program loop;
logic configured to identify live ranges of variables used within the source code program loop that exceed an initiation interval of the source code program loop;
logic configured to allocate rotating registers for each of the variables;
logic configured to assign values for each of the variables that are initiated within the source code program loop; and
logic configured to communicate with a scalar register allocator responsive to the logic configured to allocate rotating registers and the logic configured to assign values.

10. The computer-readable medium of claim 9, further comprising:
logic configured to identify live ranges that overlap the source code program loop; and
logic configured to spill live ranges responsive to the logic configured to identify live ranges that overlap the source code program loop.

11. The computer-readable medium of claim 9, wherein the logic configured to receive receives a modulo schedule.

12. The computer-readable medium of claim 11, further comprising:
logic configured to identify a location in the schedule for spill code.

13. The computer-readable medium of claim 9, further comprising:
logic configured to recognize a pipeline processed intermediate representation of the source code; and
logic configured to minimize an amount of spill code generated within the loop of interest.

14. The computer-readable medium of claim 9, further comprising:
logic configured to recognize and reassign scalar lifetime values overwritten within the loop upon exiting the programming loop.

15. The computer-readable medium of claim 9, further comprising:
logic configured to select a rotating register for an assignment of a scalar lifetime variable value.

16. The computer-readable medium of claim 15, wherein the logic configured to select is responsive to logic configured to report rotating register usage information.

17. A compiler, comprising:
means for receiving a schedule representation of a source code loop;
means for identifying live ranges of variables within the schedule representation;
means for classifying the variables responsive to when each respective variable is defined;
means for managing a plurality of rotating registers responsive to the means for classifying; and
means for communicating rotating register usage information responsive to the means for managing.

18. The compiler of claim 17, further comprising:
means for recognizing interfering variables in the schedule; and
means for spilling the interfering variables to static registers outside the loop.

19. The compiler of claim 18, further comprising:
means for restoring the interfering variables outside the loop upon termination of the schedule.

20. The compiler of claim 17, further comprising:
means for applying variables with scalar lifetimes to rotating registers responsive to the means for communicating.

21. An optimizing compiler, comprising:
a translation engine configured to receive source code and generate an intermediate representation of a source code programming loop; and
a low-level instruction optimizer, the low-level instruction optimizer further comprising a scheduler and register allocator, the scheduler and register allocator comprising:
an initiation interval determiner configured to identify where in the source code each of a plurality of variables is identified and when variables are defined within a programming loop, in which of a plurality of programming loops each respective variable is defined;
a modulo scheduler configured to receive the intermediate representation and generate a schedule responsive to the source code programming loop;
a rotating register allocator configured to receive the schedule, allocate and assign rotating registers responsive to the schedule and initiation interval, and communicate a status of a set of rotating registers;
a static register allocator configured to receive the schedule, allocate and assign scalar variables to a set of scalar registers responsive to the initiation interval determiner and the status; and
a rotating register spiller configured to receive and store interfering variables in a memory.

22. The optimizing compiler of claim 21, wherein the scheduler and register allocator further comprises an interfering lifetime identifier configured to analyze the status and the set of scalar registers to identify candidate registers for a rotating register spill operation.

23. The optimizing compiler of claim 21, wherein the static register allocator further comprises a static register spiller configured to receive and store scalar variables to an allocated and unassigned rotating register.

24. The optimizing compiler of claim 21, wherein the scalar register allocator selects a rotating register for assigning a scalar lifetime variable value.

25. The optimizing compiler of claim 24, wherein the scalar register allocator selects the rotating register for assignment responsive to the rotating register usage information.

26. The optimizing compiler of claim 24, wherein the scalar register allocator is configured to recognize a pipeline processed intermediate representation of the source code.

27. The optimizing compiler of claim 26, wherein the scalar register allocator is configured to minimize an amount of spill code generated.
